(19) United States
(12) Patent Application Publication
(10) Pub. No.: US 2003/0104124 A1
(43) Pub. Date: Jun. 5, 2003

(54) Strewing apparatus

(76) Inventors: Ian D. Pavey, Surrey (GB); Allan P. Brown, Hampshire (GB)

Correspondence Address: STEVENS DAVIS MILLER & MOSHER, LLP, 1615 L STREET, NW, SUITE 850, WASHINGTON, DC, 20036, US

(21) Appl. No.: 10/309,346

(22) Filed: Dec. 4, 2002

(30) Foreign Application Priority Data
Dec. 5, 2001 (SE) 0104076-5

(51) Int. Cl. B05D 1/36; B05D 7/00

(52) U.S. Cl. 427/180; 427/407.1

(57) ABSTRACT

Strewing apparatus (1) for even distribution of small hard particles of semi-conducting material. The strewing apparatus (1) comprises an upper charge plate (2) and a lower charge plate (3), the upper charge plate (2) having an inlet opening (20) for the introduction of the particles while the lower charge plate (3) have an outlet gap (30) for ejection of the particles. A distance D^{II} between the upper charge plate (2) and the lower charge plate (3) at a position where the outlet gap (30) is arranged is larger than a distance D^{I} between the lower charge plate (3) and the upper charge plate (2) where the inlet opening (20) is arranged. There is a voltage potential between the upper charge plate (2) and the lower charge plate (3).

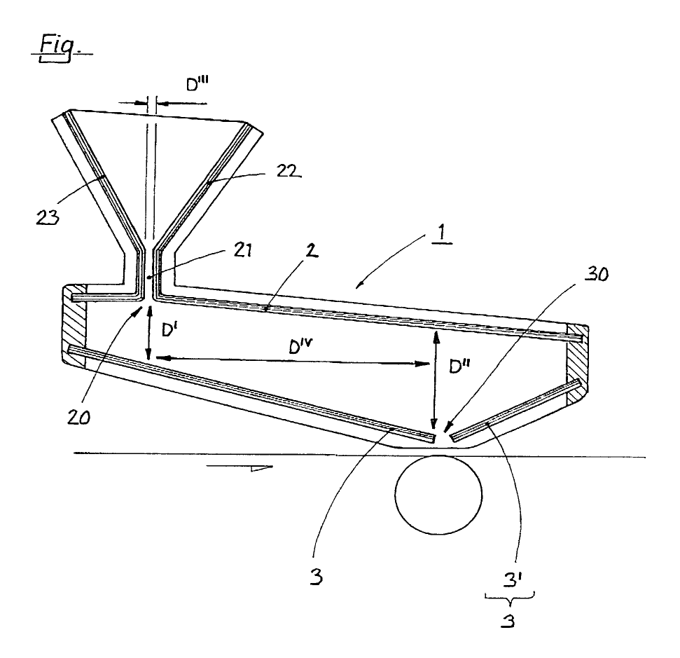

The present invention relates to an apparatus for even distribution of dry hard particles, a process for providing the surface of a web for an abrasion resistant laminate with an even layer of small, hard particles and a particle coated decor paper or overlay paper produced by the process.

Products covered with a decorative thermosetting laminate are frequently used today. They are mostly used where the demands for abrasion resistance are high, but also where a resistance against different chemicals and humidity is required. Floor boards, floor skirtings, table tops and wall panels can be mentioned as examples on such products.

Decorative thermosetting laminates are often made of two to hundreds of Kraft paper sheets impregnated with phenol-formaldehyde resin and a decor paper sheet impregnated with melamine-formaldehyde resin or another thermosetting resin. The decor paper sheet can be monochromatic or patterned for instance with a wood pattern or a fancy pattern and placed as a top layer in the laminate.

Often one or more so-called overlay sheets of cellulose usually impregnated with melamine-formaldehyde resin are placed on top of the decor paper to protect the decor paper sheet from abrasion.

There are also laminates consisting of a base layer of particle board or fibre board provided with such a decor paper sheet and possibly an overlay sheet. These sheets can be laminated towards the base layer under heat and pressure. If a decor paper only is used and no overlay sheet, the decor paper sheet can be glued towards the base layer instead.

To further increase the abrasion resistance of the decor paper sheet and/or the possible overlay sheets these may be provided with a coating of hard particles. These particles can be applied to the paper by mixing them into the thermosetting resin used for impregnating the paper. The particles can also be added to the wet cellulose fibres on the wire of a paper machine. Finally it is known to coat the resin impregnated paper with hard particles by applying the hard particles onto the paper before drying the resin.

The first method is illustrated for instance in U.S. Pat. No. 4,473,613. This method results in an uneven distribution of the hard particles and thereby an uneven abrasion resistance of the decorative laminate. The reason is that it is very difficult to disperse average size and bigger particles in a resin solution since these due to their higher density will sink to the bottom of the vessel used for storing the resin. Such a dispersion will therefore be practically unusable since the number of hard particles per surface unit will vary as time goes. This problem can partly be counteracted by increasing the viscosity of the resin solution by an addition of a thickener. However, such additives will deteriorate the properties of the resin and give a worse end result. In addition, even with a thickener it will be difficult to change the amount of hard particles per surface unit if so desired since also the resin content will be changed.

The second method mentioned above can be illustrated by the U.S. Pat. No. 3,798,111. The method disclosed in this patent is generally used for the production of overlay paper of cellulose. The hard particles for instance of aluminium oxide are then spread over a layer of wet cellulose fibres on the wire of a paper machine. With this method. the hard particles are distributed more or less irregularly within the whole fibre layer. Some of the particles even pass through the wire and cause serious pollution problems in the paper making machine. In the overlay paper obtained the hard particles will be distributed in an uncontrollable way. It is impossible to get an even distribution of the hard particles on the surface of the paper, where they give the best effect against abrasion.

In the above U.S. Pat. No. 3,798,111 a decor paper is made with the method disclosed, whereupon a decor is printed on top of the produced paper. Since the hard particles are situated below the decor they cannot possibly give an increased abrasion resistance. In spite of the disadvantages mentioned the method is widely used commercially for the production of abrasion resistant overlay sheets.

The third method mentioned above can be illustrated by our own U.S. Pat. No. 4,940,503, where the hard particles are applied to a continuous decor paper or an overlay paper which is impregnated with a liquid solution of a thermosetting resin. The resin is wet when the particles are coated on the paper. The paper is dried when the particles have been added.

The particles are distributed by means of a device comprising a container containing the hard particles and a rotating doctor-roll with an uneven surface placed under the container, whereby the particles are intended to fall from the container to the doctor-roll and then be evenly distributed on the paper web fed under the doctor-roll. The device usually contains an air knife intended to get the particles to come loose from the doctor-roll at a constant amount per unit of time.

Decorative thermosetting laminates produced for flooring boards where at least one overlay has been provided with hard particles by said method have been tremendously successful. The method is one of the best commercial one for production of highly abrasion resistant decorative thermosetting laminates. The particles are distributed very evenly on the paper web.

However, sometimes you find clusters of particles sticking together on the surface of the coated paper resulting in patchy or hazy areas. Between these clusters there are minor areas lacking particles. If the formation of such clusters could be avoided by an even better distribution of the particles the abrasion resistance would increase without addition of a higher amount of hard particles. A decrease of the cluster formations would also improve the decorative effect of the decorative laminate. Thus, there is a need for improvement of this process for even distribution of hard particles to the surface of a continuously fed paper, especially an overlay paper for abrasion resistant laminates. These laminates constitute the top layer of flooring boards which usually have a base layer of particle board or fibre board to which the laminate is glued. The flooring boards are furnished with groove and tongue in the side edges as ordinary flooring board of wood. The occurrence of patchy or hazy areas will limit the amount of particles arranged on the surface. The patchy areas themselves will have a very good abrasion resistance while neighbouring areas could be rather poor in abrasion resistance. The operator will have to reduce the amount of particles arranged on the surface until the hazy areas becomes invisible for the naked eye. The amount of particles on neighbouring areas will then be reduced even further. A more uniform dispersion of the particles will render a much increased abrasion resistance without causing problems with visual effects.

Another problem is caused by the particles themselves as they by nature are very hard in order to have the best effect in an abrasion resistant layer. Machinery with different levels of moving parts will be worn down rather quickly which will cause for continuous adjustments in order to have an even dispersion of particles. There will also be a rather frequent need for maintenance which of course causes costly interruptions in the manufacturing. It is desirable to have a strewing apparatus with as few moving parts as possible.

According to the present invention it has been possible after an extensive development work lasting for years to meet the above need. Accordingly, the present invention relates to a strewing apparatus for even distribution of small hard particles of semi-conducting material. The invention is characterised in that the strewing apparatus comprises an upper charge plate and a lower charge plate, the upper charge plate having an inlet opening for the introduction of the particles while the lower charge plate have an outlet gap for ejection of the particles. A distance D^{II} between the upper charge plate and the lower charge plate, at a position where the outlet gap is arranged, is larger than a distance D^{I} between the lower charge plate and the upper charge plate, where the inlet opening is arranged. The voltage potential between the upper charge plate and the lower charge plate is in the range 1-30 kV/cm. The voltage potential between the upper charge plate and the lower charge plate is preferably in the range 2-15 kV/cm or even more preferred in the range 3-8 kV/cm. Though it is possible in theory to use a field strength equal to the breakdown of air, being around 30 kV/cm, in practise a lower value is preferred as corona effects possibly will occur at lower field strengths, especially once the particles are introduced. This corona effect is highly depending on the design of the apparatus whereby it is important to avoid sharp edges, protruding screw heads and the like in the area between the charge plates. This implies, that if 20 mm is selected for the D^{I} distance and 40 mm is selected for the D^{II} distance, a voltage potential of 15 kV between the two charge plates would show a good result.

According to a preferred embodiment of the invention the inlet opening is comprised of a narrow gap with a distance D^{III} demarcated by lower edges of a first and a second funnel plate. The first funnel plate has the same voltage potential as the upper charge plate while the voltage potential P^{I} between the second funnel plate and first funnel plate is adjustable. It is alternatively possible to have both the first and second funnel plates isolated from the upper charge plate. Also here the voltage potential P^{I} between the second funnel plate and first funnel plate is adjustable.

The space between the first funnel plate and the second funnel plate suitably forms a primary particle reservoir. The distance D^{III} is selected for the particle range to be used and is typically 5-200 the particle size. The distance D^{III} is then preferably in the range 0.5-3 mm for the particle ranges described in the present invention. The voltage potential P^{I} between the second funnel plate and first funnel plate is preferably guided to switch between a low voltage potential P^{IO} where the particles flows free through the narrow gap and a high voltage potential P^{IC} where the particles are prevented from flowing through the narrow gap. The low voltage potential P^{IO} is suitably lower than 5 kV/cm, preferably 0 kV/cm while the high voltage potential P^{IC} is around or higher than 10 kV/cm. It is of course possible to achieve a continuous particle flow by adjusting the voltage potential to some kind of equilibrium around which the voltage potential could be fine adjusted to achieve the desired flow rate. It has however shown during experiments to be easier to exactly guide the flow rate of the particles by pulsating between no-flow and unrestricted flow. The voltage potential P^{I} between the second funnel plate and first funnel plate is accordingly preferably guided to switch between a low voltage potential P^{IO} where the particles flows free through the narrow cap and a high voltage potential P^{IC} where the particles are prevented from flowing through the narrow gap. This is achieved by means of a triangular wave with a fixed frequency which is used for guiding an electromechanical or electronic switch via a potentiometer whereby the ratio between the period in which the particles are allowed to flow between the two funnel plates and the period where the particle flow is restricted is guided. It has shown that moisture content temperature and relative humidity will to a small amount affect the flow rate of the particles. These deviations in particle flow rate is suitably adjusted by means of measuring the resistance of the particles between the first and second funnel plates. This will show itself in a current leakage through the particles in the funnel. The measurement is suitably used for automatically adjusting the peak-level and/or zero-level of the triangular wave used for guiding the particle flow rate.

The frequency of one hertz has been used for the triangular guiding wave during trials and one might think that the discontinuous introduction of particles into the electrical field between the charge plates would show on a web running at high speed. No such effects have been detected. In fact test has shown that that even frequencies as low as 0.01 Hz could be used as there is a certain inertia within the system.

The inlet opening where the particles are introduced and the outlet gap where the particles are ejected are arranged at a distance D^{IV} from each other. The distances are arranged so that D^{I}<D^{II}<D^{IV}. The distance D^{II} should be arranged to be more than 1.2×D^{I}, preferably more than 1.5×D^{I}, more preferably 2×D^{I} and most preferably the distance D^{IV} is more than 3×D^{II}. The distance D^{IV} may also be expressed in relation to the distance D^{I} where the distance D^{IV} preferably is more than 6×D^{I}. It is advantageous to arrange the lower charge plate at an angle towards the horizontal plane whereby the outlet gap is arranged at the lower portion of the lower charge plate. Build up particles on the lower charge plate will hereby be avoided.

The semi-conducting particles will bounce between the two charge plates changing polarity each time they hit a charge plate thereby being attracted to the opposite plate. Due to the angle between the two charge plates the particles will drift from the narrow end, where the particles are introduced, to the more open end where the outlet gap is located. Some particles will miss the plate and fall through the outlet gap onto the surface which is to be coated. The dispersion is extremely uniform over the whole length of the outlet gap. It is advantageous to have the same voltage potential on the surface to be coated as the lower charge plate. Of practical reasons it will come natural to have the lower charge plate connected to earth while the upper charge plate is charged with the required voltage potential. It is however fully possible, and may also show advantageous of different reasons, to have a charge on the lower charge plate as well. The charge between the lower charge plate and the surface to be coated may then suitable be up to 30% of the charge between the upper charge plate and the lower charge plate. It is suitable to have a positive charge on both the lower and upper charge plates in cases where they are both charged.

The charge plates and the funnel plates are suitably made of metal. Aluminium as well as stainless steel has proved to be usable. The different metal plates are connected to each other via side wall members, which of course should be a good isolators. The side wall members are therefore suitably made of a plastic material. There are several plastic materials that are suitable among which we would like to mention thermoplastic materials like acrylic, polycarbonate, polyamide and polypropylene as well as thermosetting materials like paper phenol laminate and glass fibre epoxy laminate. The high voltage used will of course have to be protected, suitably by a non-conducting casing even though there are no real hazards connected with touching conducting parts of the apparatus, this due to the fact that only low currents are necessary. One should, however, be aware that certain guiding equipment may provide currents large enough to be hazardous, wherefore encasing of the apparatus is advantageous. A casing is suitably also made so that disturbing air currents are avoided which also will minimise the amount of foreign objects caught in the electrical field. The strewing area under the outlet gap is suitably also protected by some kind of casing which reduces disturbing air currents so that only a laminar air flow is present between the outlet gap and the web on which the particles are to be distributed. It is also suitable to arrange a roller directly beneath the outlet gap so that the web is as free as possible from erratic vertical movements as this may affect the dispersion. It is also possible to arrange aerodynamic spoilers near the web for avoiding disturbing air streams.

The hard particles are preferably made of a semi-conducting material, for example aluminium oxide, silicon carbide or silica. If semi-conducting particles are used suitably the moisture content as well as the relative humidity is important. The ability of the semi-conducting particles to take charge and thereby be polarised is increased. The particles suitably have an average size of about 5-200 μm, preferably 10-120 μm. Usually the particles are dry, but sometimes they can contain a certain amount of liquid, preferably water. However, the liquid content should not be so high that the particles are agglomerating. As discussed above the moisture will affect the amount of particles dispersed but this may be adjusted for automatically also discussed above.

The above apparatus according to the present invention with the perfectly working charge plates arrangement for dispersing and randomising the hard particles instead of previously known methods of randomising gives an outstanding evenness of hard particles on the surface of a coated web.

The present invention also relates to a process for providing the surface of a web for an abrasion resistant laminate with an even layer of small hard particles, said process comprising impregnating a continuously fed web with a resin composition and having the surface of the paper made sticky with said resin, coating at least one side of the web with 2-30 g/m², preferably 3-20 g/m² of small and hard particles so that the particles are evenly distributed over the surface of resin on the web. The resin is then allowed to set with the particles coated thereon. The small hard particles are applied by means of an strewing apparatus for even distribution of small hard particles of semi-conducting material. The strewing apparatus comprises an upper charge plate and a lower charge plate, the upper charge plate having an inlet opening for the introduction of the particles while the lower charge plate have an outlet gap extending transversely of said fed web for ejection of the particles. A distance D^{II} between the upper charge plate and the lower charge plate, at a position where the outlet gap is arranged, is larger than a distance D^{I} between the lower charge plate and the upper charge plate, where the inlet opening is arranged. The voltage potential between the upper charge plate and the lower charge plate is in the range 1-20 kV/cm whereby the hard particles are fluidized by means of the electric field between the upper and lower charge plates resulting in an even amount of particles filling down on the paper web continuously fed under the outlet gap. The small hard particles suitably have an average particle size of about 10-150 μm. The hard particles suitably consist of silica, aluminium oxide and/or silicon carbide.

The thermosetting resin is suitably selected from the group consisting of; melamine-formaldehyde resin and radiation curing resins. A radiation curing resin is suitably selected from the group consisting of; epoxy acrylate oligomer, polyester acrylate oligomer, urethane acrylate oligomer, methacrylate olgiomer, silicon acrylate oligomer and melamine acrylate olgiomer. The resin is preferably present as an aqueous solution. The resin is suitably present in an uncured and still wet state during the application of particles. According to an alternative embodiment of the invention the resin is present in a partly cured and heated to a sticky state during the application of particles

According to one embodiment of the invention one side of the paper is provided with hard particles with an average size of about 40-150 μm, preferably 40-90 μm by the disclosed method. The other side of the paper may then be impregnated with the above thermosetting resin containing above hard particles but with a size of 1-30 μm, preferably 1-10 μm. This coating preferably gives an addition of hard particles of 1-20 g/m². Alternatively the two impregnating steps may be made on the same side of the paper with an intermediate drying step.

The present invention also relates to a particle coated decorative web, panel or sheet and/or overlay web produced by the above process.

At the production of a decorative thermosetting laminate one or more particle coated overlay web or sheets can be used together with one or more decor web or sheets with or without any hard particles.

The invention is further described in connection to an enclosed schematical drawing showing one embodiment of the invention whereby,

The figure shows schematically, in cross-section, seen perpendicularly to the travel of a web being coated with particles. Accordingly the drawing shows a strewing apparatus 1 for even distribution of small hard particles of semi-conducting material. The strewing apparatus 1 comprises an upper charge plate 2 and a lower charge plate 3. The upper charge plate 2 has an inlet opening 20 for the introduction of the particles while the lower charge plate 3 has an outlet gap 30 for ejection of the particles. A distance D^{II} between the upper charge plate 2 and the lower charge plate 3 at a position where the outlet gap 30 is arranged is two times the distance D^{I} between the lower charge plate 3 and the upper charge plate 2 where the inlet opening 20 is arranged. The voltage potential between the upper charge plate 2 and the lower charge plate 3 is in a selected embodiment, where D^{I} is 2 cm and D^{II} is 4 cm, 15 kV. The inlet opening 20 where the particles are introduced and the outlet gap 30 where the particles are ejected are arranged at a distance D^{IV} from each other. The particles will be randomised during this distance. Accordingly the distance D^{I} is smaller than the distance D^{II} while the distance D^{II} is smaller than the distance D^{IV}. The distance D^{IV} is according to the above selected embodiment 13 cm.

The lower charge plate 3 is arranged at an angle towards the horizontal plane. This will prevent build up of particles on the lower charge plate 3 which otherwise could cause occasional patches with a higher amount of particles on the surface to be coated. The outlet gap 30 will hereby be arranged at the lowest point of the lower charge plate 3. The lower charge plate 3 is also provided with far end portion 3^{I} arranged on the other side of the outlet gap 30. The far end portion 3^{I} is, in full, a part of the lower charge plate 3 and will take care of particles that overshoots the outlet gap 30. Also the part of the lower charge plate 3 forming the far end portion 3^{I} is angled so that the outlet gap 30 becomes the point closest to the surface to be coated. It is however possible to have the far end portion 3^{I} constitute a part of the lower charge plate which is charged separately.

The inlet opening 20 is comprised of a narrow gap 21 with a distance D^{III} demarcated by lower edges of a first and a second funnel plate 22 and 23 respectively. The first funnel plate 22 has hereby the same voltage potential as the upper charge plate 2 while the voltage potential P^{I} between the second funnel plate 23 and first funnel plate 22 is adjustable. The space between the first funnel plate 22 and the second funnel plate 23 forms a primary particle reservoir which can be filled either manually or through known mechanical devices. The bottom of the funnel where the first and second funnel plates 22 and 23 respectively becomes parallel forms a narrow gap 21. A distance D^{III} between the two funnel plates 22 and 23 respectively at this point is 1 mm.

The voltage potential P^{I} between the second funnel plate 23 and first funnel plate 22 is guided to switch between a low voltage potential P^{IO} where the particles flows free through the narrow gap 21 and a high voltage potential P^{IC} where the particles are prevented from flowing through the narrow gap 21. The low voltage potential P^{IO} is set at zero which means that the second funnel plate 23 has the same voltage potential as the first funnel plate 22 and the upper charge plate i.e. 15 kV according to the embodiment selected above. At this setting the particles will flow free through the column forced by gravity. The high voltage potential P^{IC} is set to 1 kV which means that the second funnel plate 23 has a voltage potential 1 kV higher or 1 kV lower than the first funnel plate 22 and the upper charge plate suitably 14 kV according to the embodiment selected above. At this setting the particles will restricted from flowing through the column.

The voltage potential P^{I} between the second funnel plate 23 and first funnel plate 22 is guided to switch between a low voltage potential P^{IC} where the particles flows free through the narrow gap 21 and a high voltage potential P^{IC} where the particles are prevented from flowing through the narrow gap 21 is achieved by means of a triangular wave with a fixed frequency of 1 Hz. This is used for guiding an electronic switch in the form of a triode via a variable voltage divider. The ratio between the period in which the particles are allowed to flow between the two funnel plates 22 and 23 respectively and the period where the particle flow is restricted is guided. As discussed earlier in the present invention, humidity among others will affect the amount of particles flowing through the narrow gap 21. These long term deviations in particle flow rate caused by deviations in temperature, relative humidity and moisture content is adjusted by means of measuring the current leakage between the first and second funnel plates 22 and 23 respectively. The current leakage measurement may be used for automatically adjusting the peak-level and/or zero-level of the triangular wave used for guiding the particle flow rate.

The strewing apparatus 1 described is advantageously used for sprinkling particles with an average particle size of about 10-150 μm which hard particles for example may consist of silica, aluminium oxide and/or silicon carbide. The strewing apparatus 1 may be used for the distribution of particles on almost any surface, but there are some advantages if that surface is sticky or wet so that the particles stays on the same surface, either by surface tension or by glue effect.

According to one embodiment of the invention the strewing apparatus 1 is used for manufacturing so-called overlay sheets which are used on laminates in order to achieve surfaces with high abrasion resistance which may be used on, for example, laminate floors. In this embodiment a paper web is impregnated with a resin and the particles are distributed on the surface of the paper web while still wet. The paper web is dried or cured after the process and is then used to form a part of a laminate according to procedures already known in the art of laminate manufacturing. The resins used may be a number of resins and may be exemplified by thermosetting resins like melamine-formaldehyde resin, urea-formaldehyde resin and phenol-formaldehyde resin or radiation curing resins like epoxy acrylate oligomer. polyester acrylate oligomer, urethane acrylate oligomer, methacrylate olgiomer, silicon acrylate oligomer and melamine acrylate olgiomer. The important feature is that the resin is, in some way, sticky in a way that the particles will remain on the surface.

When applying particles by means of a stewing apparatus according to the present invention it will be possible to apply more particles per surface unit than when using prior art equipment like for example the one shown in the U.S. Pat. No. 4,940,503. Tests have shown that hazy patches will start to become a problem when applying around 8-10 g/m² when utilising this prior art technique while a practical upper limit for the strewing device according to the present invention is around 35 g/m². This will, of course, also radically improve the abrasion resistance of decorative laminates.

The invention is not limited to the embodiment shown since this can be varied in different way within the scope of the invention. It is for example possible to vary the different dimensions given within the present application.

1. Strewing apparatus (1) for even distribution of small hard particles of semi-conducting material wherein the strewing apparatus (1) comprises an upper charge plate (2) and a lower charge plate (3), the upper charge plate (2) having an inlet opening (20) for the introduction of the particles while the lower charge plate (3) have an outlet gap (30) for ejection of the particles, that a distance D^{II} between the upper charge plate (2) and the lower charge plate (3) at a position where the outlet gap (30) is arranged is larger than a distance D^{I} between the lower charge plate (3) and the upper charge plate (2) where the inlet opening (20) is arranged and that there is a voltage potential between the upper charge plate (2) and the lower charge plate (3).

2. Strewing apparatus (1) according to claim 1 wherein the voltage potential between the upper charge plate (2) and the lower charge plate (3) is in the range 1-30 kV/cm.

3. Strewing apparatus (1) according to claim 1 wherein the voltage potential between the upper charge plate (2) and the lower charge plate (3) is in the range 2-15 kV/cm.

4. Strewing apparatus (1) according to claim 1 wherein the voltage potential between the upper charge plate (2) and the lower charge plate (3) is in the range 3-8 kV/cm.

5. Strewing apparatus (1) according to claim 1 wherein the inlet opening (20) is comprised of a narrow gap (21) with a distance D^{III} demarcated by lower edges of a first and a second funnel plate (22 and 23 respectively) whereby the first funnel plate (22) has the same voltage potential as the upper charge plate (2) while the voltage potential P^{I} between the second funnel plate (23) and first funnel plate (22) is adjustable.

6. Strewing apparatus (1) according to claim 1 wherein the inlet opening (20) is comprised of a narrow gap (21) with a distance D^{III} demarcated by lower edges of a first and a second funnel plate (22 and 23 respectively) whereby the first funnel plate (22) is isolated from the upper charge plate (2) and that the voltage potential P^{I} between the second funnel plate (23) and first funnel plate (22) is adjustable.

7. Strewing apparatus (1) according to claim 5 or 6 wherein the space between the first funnel plate (22) and the second funnel plate (23) forms a primary particle reservoir.

8. Strewing apparatus (1) according to claim 5 or 6 wherein the distance D^{III} is in the range 0.5-3 min.

9. Strewing apparatus (1) according to claim 8 wherein the voltage potential P^{I} between the second funnel plate (23) and first funnel plate (22) is guided to switch between a low voltage potential P^{IO} where the particles flows free through the narrow gap (21) and a high voltage potential P^{IC} where the particles are prevented from flowing through the narrow gap (21).

10. Strewing apparatus (1) according to claim 9 wherein the low voltage potential P^{IO} is lower than 5 kV/cm.

11. Strewing apparatus (1) according to claim 9 wherein the high voltage potential P^{IC} is higher than 10 kV/cm.

12. Strewing apparatus (1) according to claim 1 wherein the inlet opening (20) where the particles are introduced and the outlet gap (30) where the particles are ejected are arranged at a distance D^{IV} from each other.

13. Strewing apparatus (1) according to claim 12 wherein the distance D^{I}<D^{II}<D^{IV}.

14. Strewing apparatus (1) according to claim 13 wherein the distance D^{II} is more than 1.2×D^{I}.

15. Strewing apparatus (1) according to claim 13 wherein the distance D^{II} is more than 1.5×D^{I}.

16. Strewing apparatus (1) according to claim 13 wherein the distance D^{II} is more than 2×D^{I}.

17. Strewing apparatus (1) according to any of the claims 13-16 wherein the distance D^{IV} is more than 3×D^{II}.

18. Strewing apparatus (1) according to any of the claims 13-16 wherein the distance D^{IV} is more than 6×D^{I}.

19. Strewing apparatus (1) according to claim 13 wherein the lower charge plate (3) is arranged at an angle towards the horizontal plane.

20. Strewing apparatus (1) according to claim 19 wherein the outlet gap (30) is arranged at the lower portion of the lower charge plate (3).

21. Strewing apparatus (1) according to any of the claims 5-11 wherein the voltage potential P^{I} between the second funnel plate (23) and first funnel plate (22) is guided to switch between a low voltage potential P^{IO} where the particles flows free through the narrow gap (21) and a high voltage potential P^{IC} where the particles are prevented from flowing through the narrow gap (21) is achieved by means of a triangular wave with a fixed frequency which is used for guiding an electromechanical or electronic switch via a potentiometer whereby the ratio between the period in which the particles are allowed to flow between the two funnel plates (22 and 23 respectively) and the period where the particle flow is restricted is guided.

22. Strewing apparatus (1) according to claim 21 wherein deviations in particle flow rate caused by deviations in temperature, relative humidity and moisture content is adjusted by means of measuring the resistance in the particles between the first and second funnel plates (22 and 23 respectively).

23. Strewing apparatus (1) according to claim 22 wherein the current leakage measurement is used for automatically adjusting the peak-level and/or zero-level of the triangular wave used for guiding the particle flow rate.

24. Process for providing the surface of a decor web or an overlay web for an abrasion resistant laminate with an even layer of small hard particles, said process comprising impregnating a continuously fed web with a resin composition and having the surface of the web being wet or made sticky with said resin, coating at least an upper side of the web with 2-30 g/m², preferably 3-20 g/m² of small and hard particles so that the particles are evenly distributed over the surface of resin on the web, then allowing the resin to set with the particles coated thereon, the small, hard particles being applied by means of an strewing apparatus (1) for even distribution of small hard particles of semi-conducting material, the strewing apparatus (1) comprising an upper charge plate (2) and a lower charge plate (3), the upper charge plate (2) having an inlet opening (20) for the introduction of the particles while the lower charge plate (3) have an outlet gap (30) extending transversely of said fed web for ejection of the particles, that a distance D^{II} between the upper charge plate (2) and the lower charge plate (3) at a position where the outlet gap (30) is arranged is larger than a distance D^{I} between the lower charge plate (3) and the upper charge plate (2) where the inlet opening (20) is arranged and that the voltage potential between the upper charge plate (2) and the lower charge plate (3) is in the range 1-30 kV/cm whereby the hard particles are fluidized by means of the electric field between the upper and lower charge plates (2 and 3 respectively) resulting in an even amount of particles falling down on the web continuously fed under the outlet gap (30).

25. Process according to claim 24, wherein the small hard particles have an average particle size of about 5-200 μm.

26. Process according to claim 24 or 25, wherein the thermosetting resin is selected from the group consisting of; melamine-formaldehyde resin and radiation curing resins.

27. Process according to claim 26 wherein the radiation curing resin is selected from the group consisting of; epoxy acrylate oligomer, polyester acrylate oligomer, urethane acrylate oligomer, methacrylate olgiomer, silicon acrylate oligomer and melamine acrylate olgiomer.

28. Process according to any of the claims 24-27 wherein the resin is present as an aqueous solution.

29. Process according to any of the claims 24-28, wherein the hard particles consist of silica, aluminium oxide and/or silicon carbide.

30. Process according to claim 24 wherein the resin is present in an uncured and still wet state during the application of particles.

31. Process according to claim 24 wherein the resin is present in an partly cured and heated to a sticky state during the application of particles.

32. A particle coated decor and/or overlay web, panel or sheet produced by the process according to any one of claims 23-30.
